(19) United States
(12) Patent Application Publication
(10) Pub. No.: US 2016/0114388 A1
(43) Pub. Date: Apr. 28, 2016

(54) System and Method for Handling A Tundish

(71) Applicant: Phoenix Services International, LLC, Kennett Square, PA (US)

(72) Inventor: Rodney Barnes, Dyersburg, TN (US)

(21) Appl. No.: 14/848,722

(22) Filed: Sep. 9, 2015

Related U.S. Application Data
(60) Provisional application No. 62/067,852, filed on Oct. 23, 2014.

(51) Int. Cl. B22D 41/12; B66F 9/19; B66F 9/065; B22D 41/04; B22D 41/06

(52) U.S. Cl. CPC B22D 41/12; B22D 41/04; B22D 41/06; B66F 9/065; B66F 9/19

(57) ABSTRACT

The disclosure relates to a system and method for supporting, lifting, and dumping a tundish. The system includes a transporter, a carrier cradle, and a tilting mechanism. The transporter has a frame. The carrier cradle is operatively coupled to the transporter and adapted for engaging and supporting the tundish. The tilting mechanism is coupled to the transporter and coupled to the carrier cradle. The tilting mechanism includes an actuator, at least one longitudinal main arm, and a tilt linkage assembly. The tilting mechanism is configured to pivot the carrier cradle about a horizontal transverse axis for emptying contents of the tundish upon actuation by the actuator.

### CROSS-REFERENCE

This application claims the benefit under 35 U.S.C §119(e) of Provisional U.S. Patent Application No. 62/067,852 filed on Oct. 23, 2014, and entitled “SYSTEM AND METHOD FOR HANDLING A TUNDISH,” the content of which is incorporated by reference herein in its entirety.

### TECHNICAL FIELD

This disclosure relates generally to machines that transport molten material, and more particularly, to a system and method for supporting, lifting, and transporting tundish containers.

### BACKGROUND

A tundish is a broad and open container that is used in steel plants to transport molten metal. For example, the tundish allows a reservoir of metal to feed a casting machine while ladles are switched, thus acting as a buffer of hot metal, as well as smoothing out flow, regulating metal feed to the molds, and cleaning the metal. Metallic remains left inside a tundish are known as tundish skulls and need to be removed, typically by mechanical means, such as scraping or cutting.

A conventional tundish carrier is a machine that can handle and support a large load, such as a tundish, and transport it to dumping locations. The tundish carrier can have carrier assemblies that are U-shaped to fit around and access the tundish. Through the use of onboard, high-lift hydraulic mechanisms, a tundish can be lifted, supported, and transported.

Many plants have an overhead crane capable of lifting and positioning a tundish such that a tundish carrier can have access. Generally, a tundish is positioned on the ground or on a pallet such that the tundish carrier must maneuver to an appropriate position to align with and lift the tundish. Current methods require a conventional tundish carrier to have the ability to maneuver in a certain way and to lift a load to a certain height. Therefore, tundish machines require significant power and agility in order to successfully lift, transport, and dump a tundish.

Another method of handling material in a tundish includes directly dumping the molten metal into a pit in the ground. As the metal hardens, it is dugout or de-skulled using mechanical devices. This method requires a defined area with certain specifications that can withstand molten metal, and it also raises safety concerns.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

An aspect of the present disclosure includes a tundish handling system and method for lifting, transporting, and dumping a tundish. The tundish handling system includes a tundish machine for supporting the tundish. The tundish machine includes a tundish carrier, a carrier cradle, and a tilting mechanism. The tundish carrier includes a frame, or body, and wheels. The carrier cradle is operatively coupled to the tundish carrier and adapted for engaging and supporting the tundish. The tilting mechanism is coupled to the tundish carrier and to the carrier cradle and includes an actuator, at least one longitudinal main arm, and a tilt linkage assembly. The actuator is coupled to the tundish carrier. The at least one longitudinal main arm is operatively coupled to the actuator. The tilt linkage assembly is coupled to the at least one longitudinal arm and to the carrier cradle. The tilting mechanism is configured to pivot the carrier cradle about a horizontal transverse axis for emptying contents of the tundish upon actuation by the actuator.

Another aspect of the present disclosure includes a method for handling a tundish with a tundish handling system. The tundish handling system includes a tundish carrier and intermediate cradle. The method includes engaging the tundish by a tundish cradle, whereby the tundish is positioned on the intermediate cradle. The tundish cradle is operatively coupled to the tundish carrier. The method further includes lifting the tundish, by the tundish cradle, from the intermediate cradle. The intermediate cradle may include at least one collapsible pier. The at least one collapsible pier has an extended position and a retracted position. In the extended position the pier supports at least a portion of the tundish such that the tundish is approximately horizontal. In the retracted position, the piers are collapsed to enhance access to the tundish by the tundish carrier, thereby aiding in the removal of the tundish from the intermediate cradle by the tundish cradle.

Another aspect of the present disclosure includes a transportable tundish carrier assembly for supporting a tundish. The transportable tundish carrier assembly includes a carrier cradle and a tilting mechanism. The carrier cradle is adapted for engaging and supporting the tundish. The tilting mechanism is coupled to the carrier cradle. The tilting mechanism includes an actuator, a forward linkage arm that is operatively coupled to the actuator, and a nonlinear linkage arm that is operatively coupled to the forward linkage arm and operatively coupled to the carrier cradle. The tilting mechanism is configured to pivot the carrier cradle about a horizontal transverse axis for emptying contents of the tundish upon actuation by the actuator.

### BRIEF DESCRIPTION OF THE DRAWINGS

FIG. 1A is an illustration of a side view of a tundish handling system in a raised position, according to one aspect of the disclosure.

FIG. 1B is an illustration of a side view of a tundish handling system in a lowered position, according to one aspect of the disclosure.

FIG. 1C is an illustration of a top view of tundish handling system in a lowered position, according to one aspect of the disclosure.

FIG. 2A is an illustration of an aspect of a tundish carrier and a carrier assembly in a dumping position.

FIG. 2B is an illustration of an aspect of a tundish carrier and a carrier assembly in a transport position.

FIG. 3A is an illustration of another aspect of a front view of a tundish carrier and a carrier assembly.

FIG. 3B is an illustration of another aspect of a back view of a tundish carrier and a carrier assembly.

FIG. 4 is an illustration a side view of a carrier cradle, according to one aspect of the disclosure.

FIG. 5 is an illustration of an aspect of a tundish support assembly.

FIG. 6 is an illustration of an aspect of a tundish support assembly supporting a tundish.

### DETAILED DESCRIPTION

The invention now will be described more fully hereinafter with reference to the accompanying drawings. This disclosure may, however, be embodied in many different forms and should not be construed as limited to the embodiments set forth herein; rather, these embodiments are provided so that this disclosure will be thorough and complete, and will fully convey the scope of the disclosure to those of ordinary skill in the art.

The disclosure relates to a tundish handling system and method for supporting, transporting, lifting, and dumping a tundish. A conventional crane or other means may lift the tundish onto a cradle or support means. A tundish handling machine may engage the tundish and lift it from the cradle. The tundish handling machine may be wheeled so that it moves the tundish from the cradle and transports it to a dumping location. At the dumping location, the tundish may be rotated or pivoted to dump the contents of the tundish. The contents of the tundish may include molten slag, molten metal, skulls, or combinations thereof.

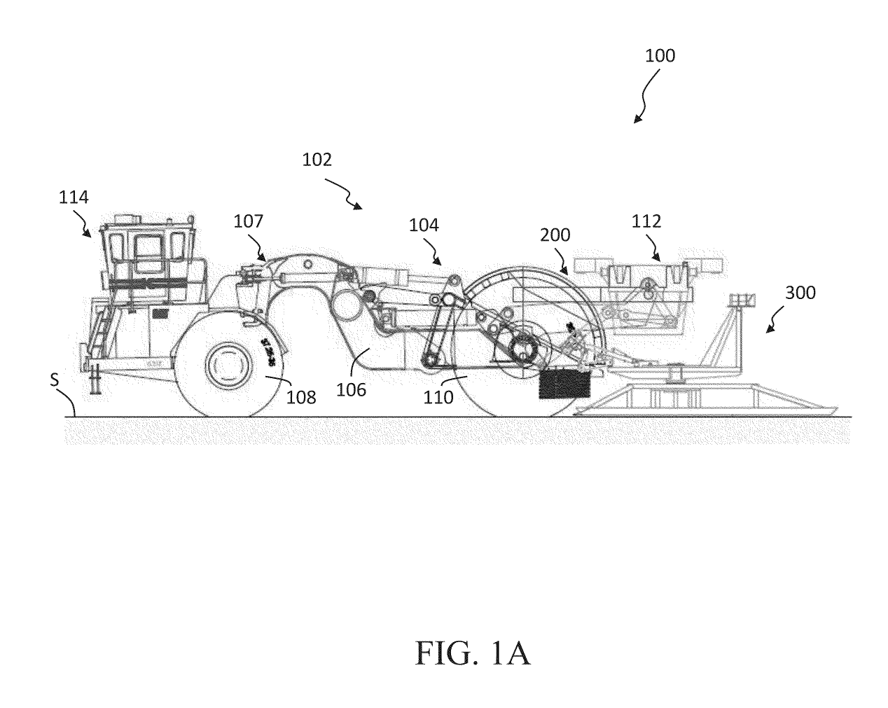

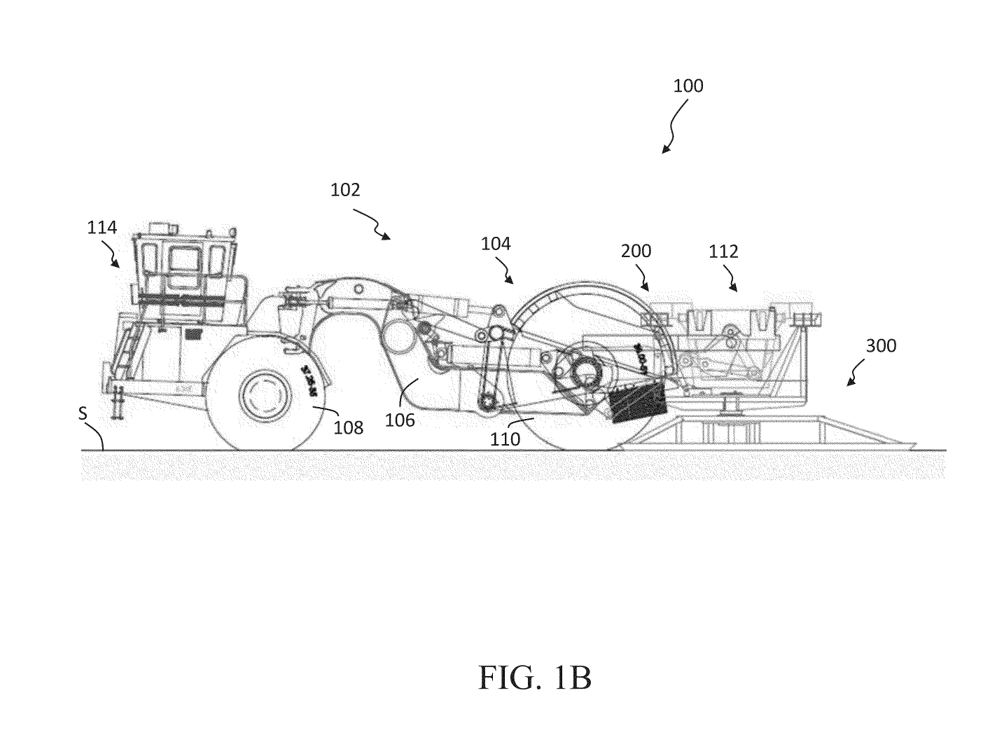

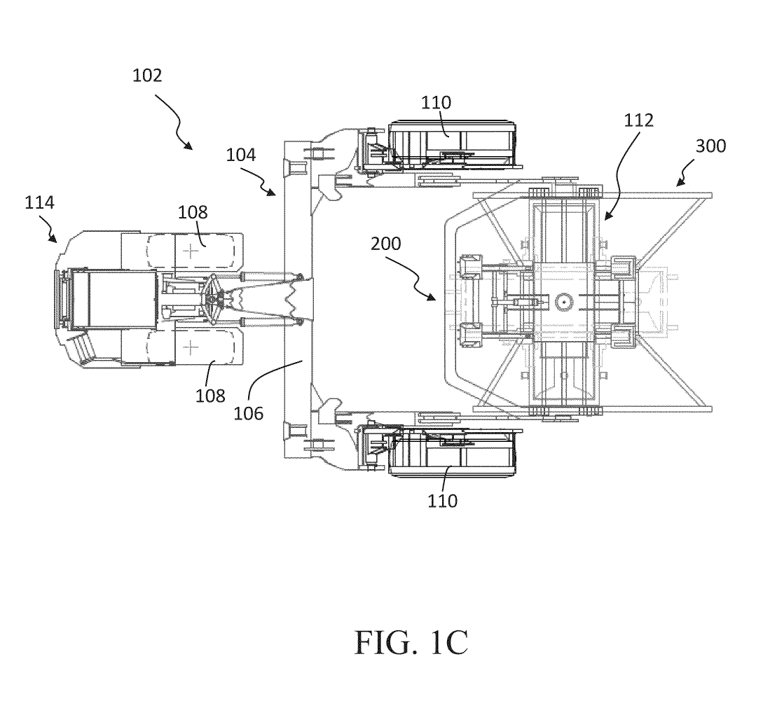

FIGS. 1A, 1B, and 1C illustrate a tundish handling system 100, according to an aspect of this disclosure. FIGS. 1A and 1B illustrate a side view of the tundish handling system 100 in a raised position and a lowered position, respectively. FIG. 1C is a top view of the tundish handling system 100 in a lowered position.

The tundish handling system 100 comprises a tundish handling machine 102 and a tundish cradle or support assembly 300. The tundish handling machine 102 includes a transporter or tundish carrier 104 and a carrier assembly 200. The tundish carrier 104 preferably is a self-propelled vehicle that includes a body or frame 106, tractor wheels 108, and trailer wheels 110 for lifting and moving a tundish 112 in carrier assembly 200. It will be appreciated that the tundish carrier 104 may also be referred to as a transporter. The invention is not limited to the particular style of carrier 104 or transporter shown in the figures, but rather encompasses any kind of carrier capable of lifting and transporting large loads. The frame 106 inter-operatively connects and associates various physical and structural features that enable the tundish machine 102 to function, as will be clear to persons familiar with conventional tundish transport technology. These features include an operator cab portion 114 positioned above the tractor wheels 108, from which an operator may control and direct operation of the tundish machine 102. The operator cab portion 114 may be coupled to the tundish carrier 104 at pivot point 107, such that the tundish carrier 104 may rotate about pivot point 107 with respect to the operator cab portion 114. Additionally, a steering feature (not shown) and similar controls may be located within the operator cab portion 114. To propel the tundish machine 102 over the surface S, a power system (not shown), such as an internal combustion engine, can also be mounted to the frame 106 and can generate power that is converted to physically move the tundish machine 102.

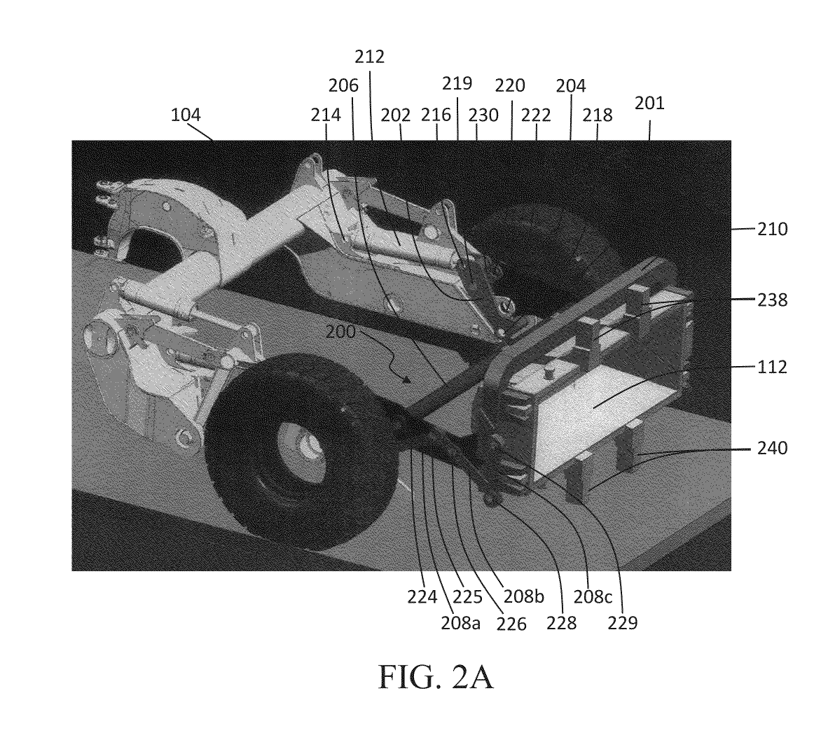

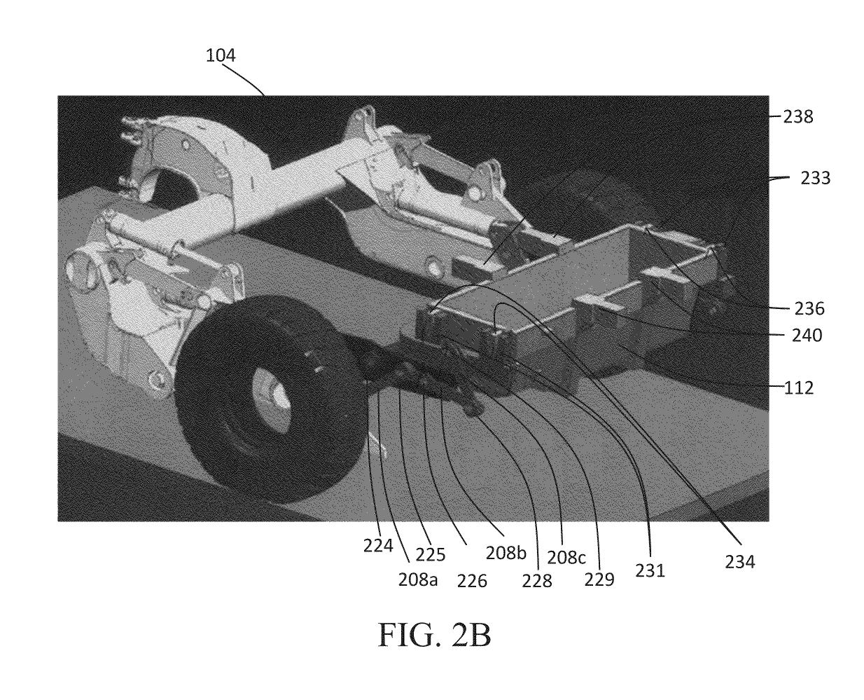

FIGS. 2A and 2B illustrate the carrier assembly 200 in a dumping position and a transporting position, respectively. The carrier assembly 200 includes a tilting mechanism 201 and a carrier cradle 210. The carrier assembly 200 is operably connected to the tundish carrier 104 at hinge joints 216, 218, and 222. It will be appreciated that fewer or more components may be used to operably connect the carrier assembly 200 to the tundish carrier 104 according to the particular configuration resulting from the desired functional parameters.

The tilting mechanism 201 includes an intermediate arm 202, a main arm 204, a second main arm 224, a cross member 206, and tilt linkage arms 208a, 208b, and 208c. The intermediate arm 202 is coupled to a hydraulic cylinder 212 by the hinge joint 216 and coupled to the tundish carrier 104 by a hinge joint 214. The cylinder 212 is coupled to the tundish carrier 104 by hinge joint 214. The cylinder 212 is configured to extend and retract and may rotate as needed about each hinge joint 214/216. The intermediate arm 202 is connected to the tundish carrier 104 by the hinge joint 218, whereby when the hydraulic cylinder 212 extends and retracts, the intermediate arm 202 rotates about the hinge joint 218. The intermediate arm 202 is operatively coupled to the main arm 204 by an intermediate connection member 230 and hinge joint 220. The intermediate connection member 230 may be coupled to the intermediate arm 202 by hinge joint 219. In an aspect, hinge joint 219 may be a rigid joint. The main arm 204 is connected to the tundish carrier 104 by the hinge joint 222, whereby the rotation of the intermediate arm 202 causes rotation of the main arm 204 about the hinge joint 222. The term “hinge joints” used herein encompasses any pivot, such as pin joints or other types of revolute joints that allow for rotation about a connection.

Referring to the aspect in FIG. 2A, a second main arm 224, which in the embodiment in the figures is connected to the tundish carrier 104 and a second intermediate arm (not shown) in a substantially similar manner as the connections between the main arm 204, the tundish carrier 104, and the intermediate arm 202. In this regard, arms 204 and 224 are left and right structural arms. Additionally, the second intermediate arm may be connected to the tundish carrier 104 and a second cylinder (not shown) in substantially the same manner as how the intermediate arm 202 is connected to the tundish carrier 104 and the cylinder 212. The second cylinder may also be connected to the tundish carrier 104 in substantially the same manner as the cylinder 212. Unless specified otherwise, use of the word “substantially” herein is intended to mean considerable in extent or largely but not necessarily wholly that which is specified.

The cross member 206 is connected to the main arm 204 and to the second main arm 224. The connection between the cross member 206 and the main arm 204 and second main arm 224 preferably is a rigid connection, and a pivotable connection or not cross member at all is contemplated.

The first tilt linkage arm 208a has a first end and a second end. The first end may be coupled to the tundish carrier 104 by a hinge joint (not shown). The second tilt linkage arm 208b has a first end, a second end, and a longitudinal shaft. The first end of the second tilt linkage 208b arm may be coupled to the second end of the first tilt linkage arm 208a by hinge joint 225. The longitudinal shaft of the second tilt linkage arm 208b may be coupled to the second main arm 224 by hinge joint 226. The third tilt linkage arm 208c has a first end and a second end. The first end of the third tilt linkage arm 208c may be coupled to the second end of the second tilt linkage arm 208b by hinge joint 228. The second end of the third linkage arm 208c may be coupled to the carrier cradle 210 by hinge joint 229. The third linkage arm 208c is coupled to the carrier cradle 210 in such a way that when the arm 208c rotates about hinge joint 228 the carrier cradle 210 may be tilted. It should be appreciated that one or more sets of tilt linkage arms 208a, 208b, and 208c may be connected in such a way as to tilt the carrier cradle 210. The sets of tilt linkage arms 208a, 208b, and 208c may be referred to as the tilt linkage assembly.

The carrier cradle 210 in operation is operatively coupled to the tundish carrier 104. The carrier cradle 210 is operatively coupled to the main arms 204 and 224. The carrier cradle 210 as shown in the figures is a U-shape and configured to allow a tundish 112 to be engaged and supported therein. FIG. 2B illustrates the carrier assembly 200 in a raised or transport position with the tundish 112 supported by the carrier cradle 210. The carrier cradle 210 includes two sets of support brackets 231 and 233 to maintain the position of the tundish 112 within the cradle.

The cradle 210 is configured to support and carry the tundish 112 In this regard, the tundish 112 may include two sets of tundish cradle support arms 234 and 236. The tundish cradle support arms 234 and 236 may align with support brackets 231 and 233, respectively, of the carrier cradle 210. The tundish 112 may also include two sets of tundish support arms 238 and 240. The tundish support arms 238 and 240 may be configured to support the weight of the tundish 112 and allow an overhead crane, or the like, to lift, handle, or otherwise move the tundish 112 from one location to another.

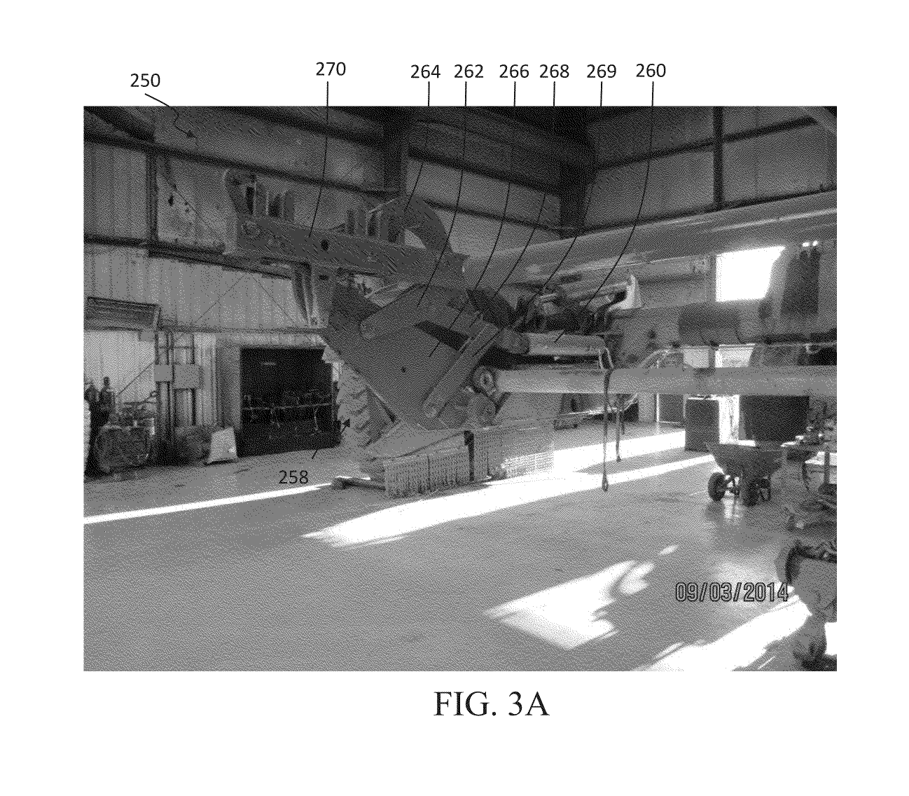

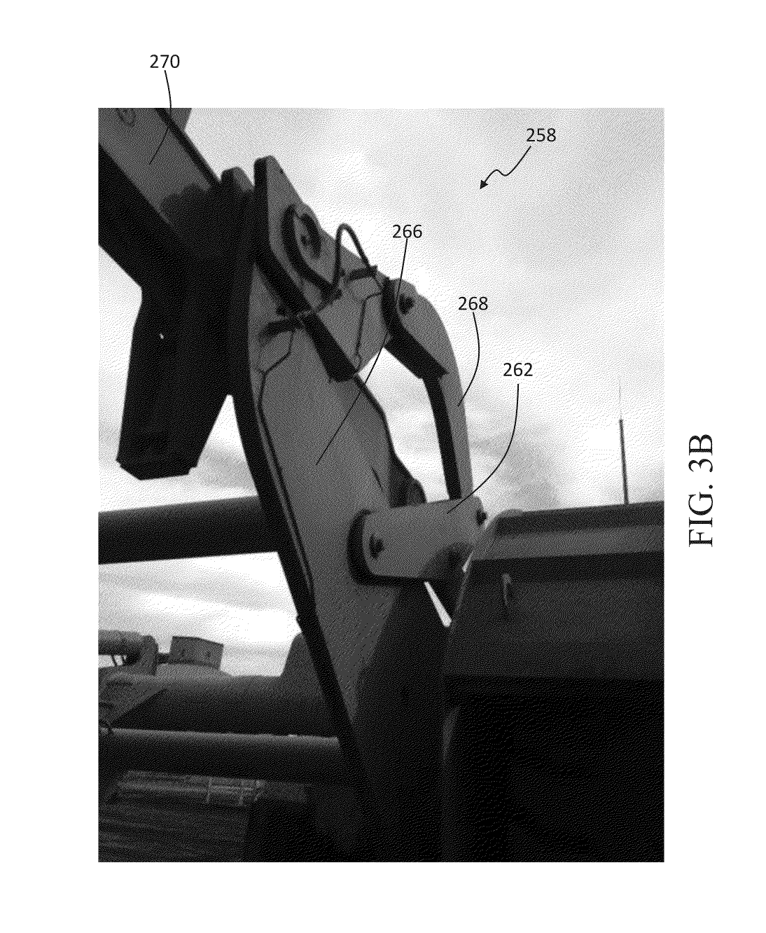

FIGS. 3A and 3B illustrate a front and back view of a carrier assembly 250, respectively, according to another embodiment of the device. The carrier assembly 250 has a tilting mechanism 258 that includes an actuator 260, a forward linkage arm 262, and a nonlinear linkage arm 264, such as an arcuate or curved linkage. The forward linkage arm 262 is operatively coupled to the actuator 260, and the nonlinear linkage arm 264 is operatively coupled to the forward linkage arm 262 and operatively coupled to a carrier cradle 270, as explained more fully below. The tilting mechanism 258 further includes a main support arm 266 rotatably connected to the forward linkage arm 262, a first intermediate arm 268 rotatably connected to the forward linkage arm 262 and rotatably connected to the actuator 260, and a second intermediate arm 269 rotatably connected to the main support arm 266 and the first intermediate arm 268. The main support arm 266, the first intermediate arm 268, the second intermediate arm 269, and the forward linkage arm 262 may compose a 4-bar linkage.

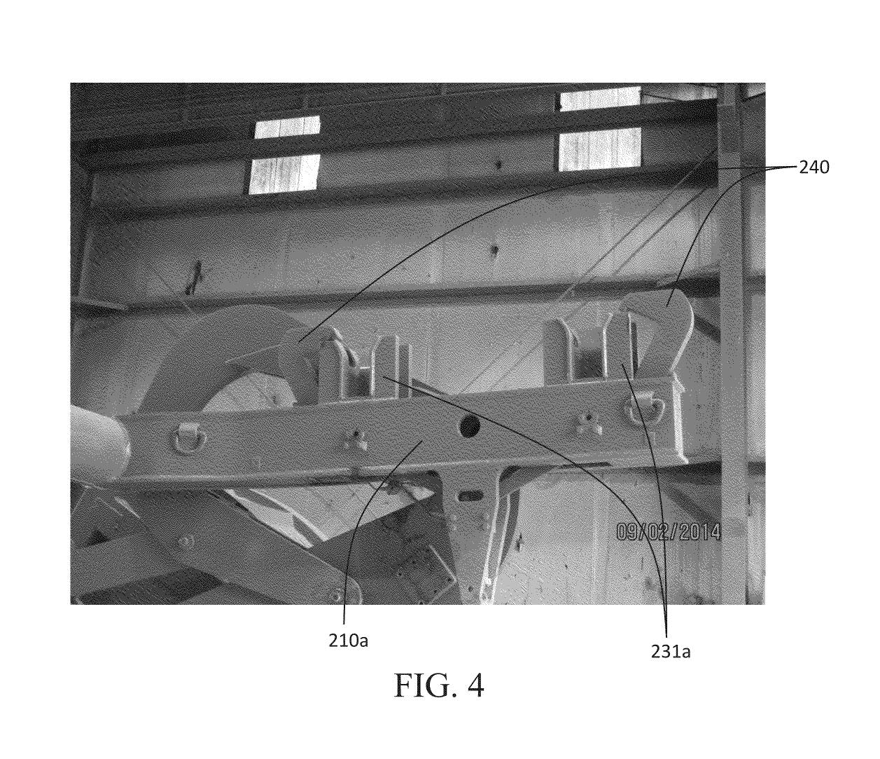

FIG. 4 illustrates a side view of a carrier cradle 210a, according to another embodiment of the device. In this illustration, locking arms 240 are coupled to the carrier cradle 210a and are in an unlock position. The locking arms 240 are configured to transition from an unlock position to a lock position, and vice versa. In the lock position (not shown), the locking arms 240 secure the tundish 112 within the carrier cradle 210a when the tundish 112 is supported by the cradle 210a. When the tundish cradle support arms 234 or 236 are supported by the support brackets 231a, the locking arms 240 effectively cover the tundish cradle support arms 234 or 236 within the support brackets 231a, thereby securing the tundish 112 to the carrier cradle 210a. In the unlock position, the locking arms 240 are positioned to allow the tundish cradle support arms 234 or 236 to be removed from the support brackets 231a, thereby allowing the tundish 112 to be released from the cradle 210a. The locking arms 240 may be controlled manually by an operator or may be controlled automatically by sensing whether the tundish 112 is supported within the cradle 210a. It will be appreciated that the number of locking arms 240 used to secure the tundish 112 within the cradle 210a may vary.

In an example of a method of operating the carrier assembly 200, an actuator provides a force to the tilting mechanism 201. Cylinder 212 may act as an actuator and provide a force to the intermediate arm 202 via hinge joint 216. When the carrier assembly 200 is in the lift or raised position (FIG. 2B) the cylinder 212 is in a retracted position. As the cylinder 212 extends, it forces the intermediate arm 202 to rotate about the hinge joint 218. The rotation of the intermediate arm 202 causes the main arm 204 and/or the second main arm 224 to rotate about their respective pivots to the tundish carrier 104 in the same direction as the rotation of the intermediate arm 202 about hinge joint 218. Main arm 204 and/or 224 is connected at its proximal end at hinge points 220 and 222 such that movement of intermediate arm 202 causes main arm 204 to move distally. The rotational movement of of arms 204/224 causes the first linkage bar 208a to rotate with respect to its pivot (not shown) to the tundish carrier 104 also in the same direction as the intermediate arm 202 about hinge joint 218. The rotation of the second main arm 224 and the rotation of the first linkage bar 208a cause the second linkage bar 208b to rotate with respect to the coupling to the second main arm 224 by hinge joint 226 in the same direction as the first linkage bar 208a. The third linkage bar 208c rotates about hinge joint 228 in the same direction as the second linkage bar 208b, causing the carrier cradle 210 to rotate about hinge joint 229 in the same direction as the third linkage bar 208c. FIG. 2A illustrates the carrier cradle 210 in a dumping position rotated 90 degrees about hinge joint 229 during the method of operating the carrier assembly 200. In an aspect of this disclosure, the carrier cradle 210 may rotate up to 180 degrees about hinge joint 229 to allow the contents of the tundish 112 to be substantially removed.

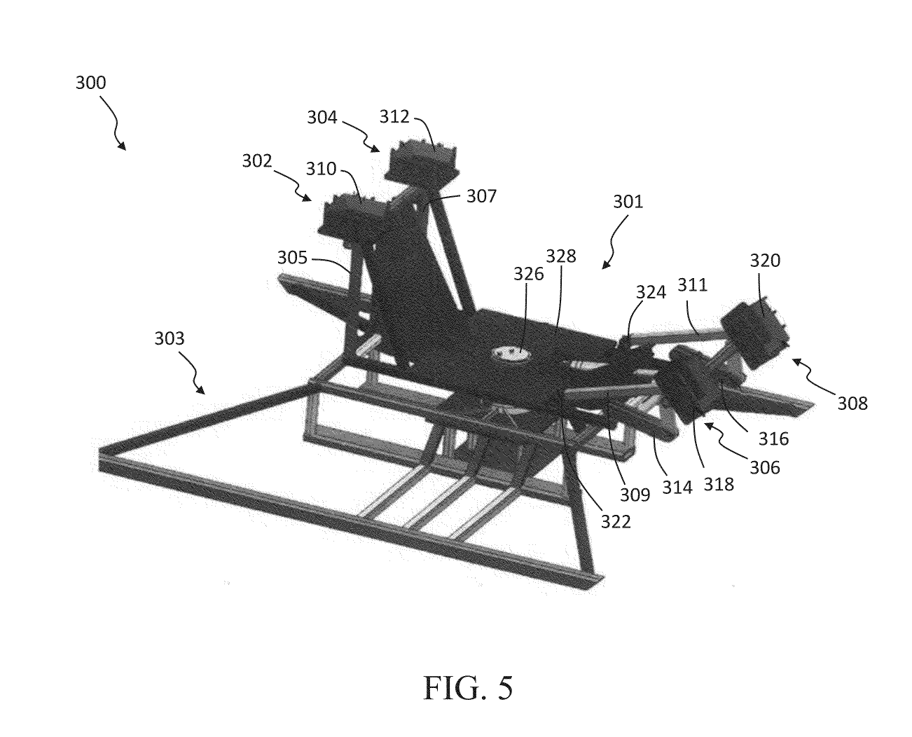

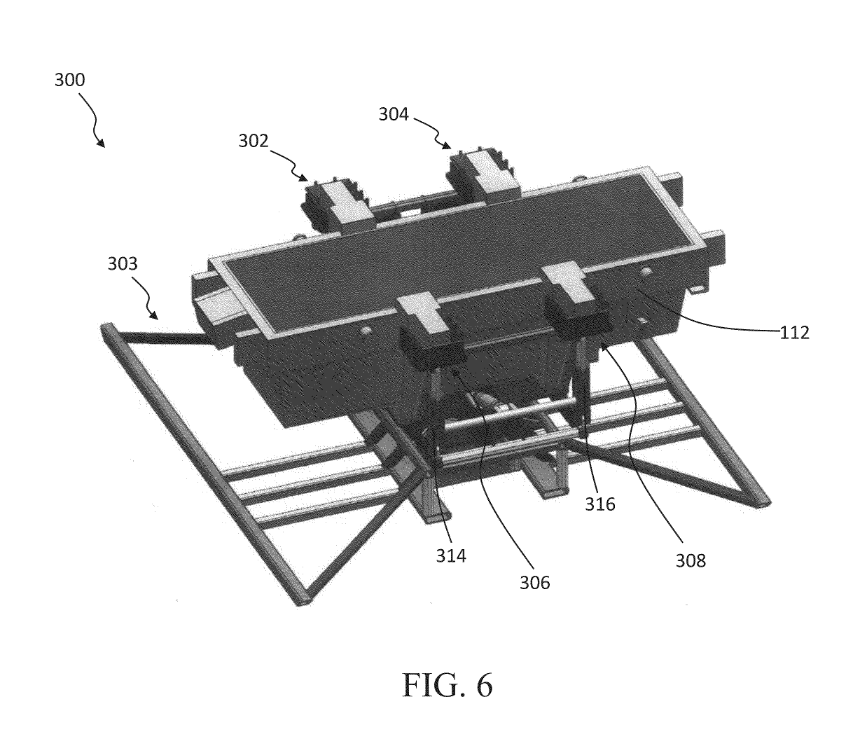

FIGS. 5 and 6 illustrate the tundish support assembly 300, which is configured to support and receive the tundish 112. The tundish support assembly 300 includes an intermediate cradle 301 and a turntable 303. The intermediate cradle 301 includes a pair of fixed arm assemblies 302 and 304 and a pair of collapsible arm assemblies 306 and 308. The fixed arm assemblies 302 and 304 include fixed arms 305 and 307 each having support pads 310 and 312, respectively, adapted for receiving a set of tundish support arms 238 or 240. The collapsible arm assemblies 306 and 308 include gusset arms 309 and 311 and collapsible piers 314 and 316 each having support pads 318 and 320, respectively. The support pads 318 and 320 are adapted for receiving a set of tundish support arms 238 or 240. The gusset arms 309 and 311 are coupled to the intermediate cradle 301 via hinge joints 322 and 324, respectively. The collapsible piers 314 and 316 may extend and retract causing the gusset arms 309 and 311 to rotate about the hinge joints 322 and 324. In the extended position (FIG. 6), the collapsible piers 314 and 316 cause the collapsible arm assemblies 306 and 308 to support the tundish 112, such that the tundish 112 is approximately horizontal and the tundish opening (not labeled) faces upward. While transitioning from the extended position (FIG. 6) to the retracted position (FIG. 5), the collapsible piers 314 and 316 cause the gusset arms 309 and 311 to rotate about hinge joints 322 and 324, respectively, enhancing access to the tundish 112 by the tundish carrier 104, whereby the removal of the tundish 112 from the intermediate cradle 301 is simplified. It will be appreciated that the collapsible piers 314 and 316 may be replaced by fixed piers (not shown), such that the collapsible arm assemblies 306 and 308 are rotatably fixed to the intermediate cradle 301.

The intermediate cradle 301 may be mounted onto the turntable 303. The intermediate cradle 301 is configured to rotate about a vertical axis from 0 to 360 degrees relative to the turntable 303. The rotation of the intermediate cradle 301 allows the tundish 112 to be rotated into a position which allows the tundish machine 102 to have easier access. In an aspect, a crane (not shown) may load the tundish 112 onto the tundish support assembly 300 whereby the length of the tundish 112 is pointed towards the tundish machine 102. In order for the tundish machine 102 to access the tundish 112, the intermediate cradle 301 may be rotated 0 to 360 degrees, allowing the carrier assembly 200 of the tundish machine 102 to receive and support the tundish 112.

The intermediate cradle 301 may also include a tundish actuator 326. The tundish actuator 326 may be positioned on the base 328 of the intermediate cradle 301. The tundish actuator 326 may be configured to control the collapsible arms 314 and 316 from an extended position to a retracted or collapsed position. When a tundish 112 is lowered onto the intermediate cradle 301, the actuator is activated and the collapsible arms 314 and 316 are controlled to an extended position. The fixed arm assemblies 302 and 304 and the collapsible arm assemblies 306 and 308 may then support the tundish 112. As the tundish 112 is raised up from the intermediate cradle 301, the tundish actuator 326 may control the collapsible piers 314 and 316 to the retracted or collapsed position, thereby allowing the tundish 112 to be easily removed.

A method for using the tundish handling system 100 may include an operator of a crane (not shown) lowering the tundish 112, filled with a molten material, onto the intermediate cradle 301 of the tundish support assembly 300. The collapsible piers 314 and 316 may extend, whereby the collapsible arm assemblies 306 and 308 and the fixed arm assemblies 302 and 304 each support at least a portion of the tundish 112. The tundish 112 may be rotated on the intermediate cradle 301 to orient the tundish 112 such that the tundish machine 102 has access to the tundish 112 and the tundish cradle 210 may engage the tundish 112. Once the tundish 112 is engaged by the tundish cradle 210, the tundish 112 may be lifted from the intermediate cradle 301 and lifted over the collapsed piers 314 and 316. In an aspect of this disclosure, the collapsed piers 314 and 316 may be rotatably fixed with respect to the tundish cradle 301, whereby the tundish 112 would be lifted above the collapsed piers 314 and 316 to remove the tundish from the tundish support assembly 300. The tundish 112 may then be transported to a dumping site and tilted by the tilting mechanism 201. The operator may control the tilting mechanism to rotate the tundish 112 up to 180 degrees so that the tundish opening (not labeled) faces in a downward direction, allowing any contents of the tundish 112 to be substantially removed. It should be appreciated that more than one operator may be required to handle the tundish 112.

After completing the dumping process, the tundish machine 102 may return the tundish 112 to the intermediate cradle 301 of the tundish support assembly 300. The intermediate cradle 301 may rotate to a position that will allow the crane to pick up the tundish 112 and begin the process over.

While the disclosure is described herein using a limited number of embodiments, these specific embodiments are not intended to limit the scope of the disclosure as otherwise described and claimed herein. Modification and variations from the described embodiments exist. More specifically, the following examples are given as a specific illustration of embodiments of the claimed disclosure. It should be understood that the invention is not limited to the specific details set forth in the examples.

What is claimed:

1. A tundish handling system including a tundish handling machine for supporting a tundish, the tundish handling machine comprising:
a transporter having a frame;
a carrier cradle operatively coupled to the transporter and adapted for engaging and supporting the tundish; and
a tilting mechanism coupled to the transporter and coupled to the carrier cradle, the tilting mechanism including:
an actuator coupled to the transporter,
at least one longitudinal main arm operatively coupled to the actuator, and
a tilt linkage assembly coupled to the at least one longitudinal main arm and coupled to the carrier cradle,
wherein the tilting mechanism is configured to pivot the carrier cradle about a horizontal transverse axis for emptying contents of the tundish upon actuation by the actuator.

2. The tundish handling system of claim 1, wherein the tilting mechanism is configured to move the carrier cradle downward allowing the carrier cradle to pivot about its horizontal transverse axis.

3. The tundish handling system of claim 1, wherein the tilting mechanism further comprises at least one intermediate arm having a first end, a second end, and a longitudinal shaft, wherein the first end of the at least one intermediate arm is coupled to the actuator and the second end of the at least one intermediate arm is coupled to the transporter, and wherein the at least one longitudinal main arm is operatively coupled to the at least one intermediate arm along its longitudinal shaft.

4. The tundish handling system of claim 3, wherein the tilting mechanism further comprises at least one intermediate connection member having a first end and a second end, wherein the first end is coupled along the longitudinal shaft of the at least one intermediate arm and the second end is coupled to the at least one longitudinal main arm.

5. The tundish handling system of claim 1, wherein the at least one main arm is coupled to the transporter.

6. The tundish handling system of claim 1, wherein the tilt linkage assembly comprises:
a first linkage arm having a first end and a second end, wherein the first end is coupled to the transporter,
a second linkage arm having a first end, a second end, and a longitudinal shaft, wherein the first end of the second linkage arm is coupled to the second end of the first linkage arm, and wherein the at least one longitudinal main arm is coupled to the second linkage arm along its longitudinal shaft, and
a third linkage arm having a first end and a second end, wherein the first end of the third linkage arm is coupled to the second end of the second linkage arm, and wherein the second end of the third linkage arm is coupled to the carrier cradle.

7. The tundish handling system of claim 1, further comprising:
an intermediate cradle adapted for receiving the tundish, the intermediate cradle including at least one pair of fixed arm assemblies, wherein each at least one pair of fixed arm assemblies include a support pad adapted for receiving a tundish support arm.

8. The tundish handling system of claim 7, wherein the intermediate cradle further includes a pair of collapsible arm assemblies, wherein each of the collapsible arm assemblies includes a second support pad adapted for receiving a tundish support arm.

9. The tundish handling system of claim 8, wherein each of the collapsible arm assemblies includes a collapsible pier, wherein each collapsible pier has an extended position in which each pier supports the tundish such that the tundish is approximately horizontal and a collapsed, retracted position to enhance access to the tundish by the transporter and thereby aid in the removal of the tundish from the intermediate cradle by the transporter.

10. The tundish handling system of claim 8, wherein the tundish handling system includes a turntable on which the intermediate cradle is mounted, whereby the turntable is capable of turning (usually by 90 degrees) the tundish about a vertical (or near vertical) axis into a position to be ready for lifting by the transporter.

11. The tundish handling system of claim 9, wherein the intermediate cradle further comprises a tundish actuator, wherein when the tundish is positioned on the intermediate cradle the collapsible piers are actuated by the tundish actuator to be in the extended position, and wherein when the tundish is removed from the intermediate cradle the collapsible piers are actuated by the tundish actuator to be in the retracted position.

12. A method for handling a tundish with a tundish handling system, the tundish handling system including a transporter and intermediate cradle, the method comprising:
engaging the tundish by a carrier cradle, wherein the carrier cradle is operatively coupled to the transporter, and wherein the tundish is positioned on the intermediate cradle; and
lifting the tundish, by the tundish cradle, from the intermediate cradle, wherein the intermediate cradle includes at least one collapsible pier, wherein the at least one collapsible pier has an extended position in which the pier supports at least a portion of the tundish such that the tundish is approximately horizontal and a retracted position to enhance access to the tundish by the transporter and thereby aid in the removal of the tundish from the intermediate cradle by the tundish cradle.

13. The method of claim 12, further comprising:
lowering the tundish onto the intermediate cradle; and
extending the at least one collapsible pier from the retracted position to the extended position, wherein at least a portion of the tundish is supported by the at least one collapsible pier.

14. The method of claim 12, further comprising:
orienting the tundish on the intermediate cradle whereby the tundish cradle can engage the tundish, wherein orienting the tundish is performed prior to engaging and lifting the tundish from the intermediate cradle.

15. The method of claim 12, further comprising:
transporting the tundish, by the transporter, from the intermediate cradle to a first location.

16. The method of claim 15, further comprising:
tilting the tundish at the first location, wherein one or more contents of the tundish are removed.

17. The method of claim 16, wherein a tilting mechanism is coupled to the transporter and coupled to the carrier cradle, wherein the tilting mechanism includes an actuator, at least one longitudinal arm, and a tilt linkage assembly, wherein the actuator is coupled to the transporter, the at least one longitudinal main arm is operatively coupled to the actuator, and the tilt linkage assembly is coupled to the at least one longitudinal main arm and coupled to the carrier cradle, and wherein the tilting mechanism is configured to pivot the carrier cradle about a horizontal transverse axis for removing one or more contents from the tundish upon actuation by the actuator.

18. A transportable tundish carrier assembly for supporting and emptying a tundish, comprising:
a carrier cradle adapted for engaging and supporting the tundish; and
a tilting mechanism coupled to the carrier cradle, the tilting mechanism including:
an actuator,
a forward linkage arm operatively coupled to the actuator, and
a nonlinear linkage arm operatively coupled to the forward linkage arm and operatively coupled to the carrier cradle,
wherein the tilting mechanism is configured to pivot the carrier cradle about a horizontal transverse axis for emptying contents of the tundish upon actuation by the actuator.

19. The transportable tundish carrier assembly of claim 18, wherein the tilting mechanism further comprises:
a main support arm rotatably coupled to the forward linkage arm;
a first intermediate arm rotatably coupled to the forward linkage arm; and
a second intermediate arm rotatably coupled to the main support arm, the first intermediate arm, and the actuator.

20. The transportable tundish carrier assembly of claim 19, wherein the main support arm, the first intermediate arm, the second intermediate arm, and the forward linkage arm compose a 4-bar linkage.

21. The transportable tundish carrier assembly of claim 18, wherein the nonlinear linkage arm is arcuate.
